(19) United States
(12) Patent Application Publication
(10) Pub. No.: US 2007/0252696 A1
(43) Pub. Date: Nov. 1, 2007

(54) GEO-LOCATION SYSTEM, METHOD AND APPARATUS

(76) Inventors: Timothy F. Belisle, White Bear Lake, MN (US); Thomas J. Belisle, Hugo, MN (US)

Correspondence Address: MCKEE, VOORHEES & SEASE, P.L.C., 801 GRAND AVENUE, SUITE 3200, DES MOINES, IA, 50309-2721, US

(21) Appl. No.: 11/381,097

(22) Filed: May 1, 2006

(51) Int. Cl. G08B 13/14; G08B 5/22; G06Q 30/00

(52) U.S. Cl. 340/572.1; 340/825.49; 235/385

(57) ABSTRACT

A method of tracking assets, such as assets associated with a vehicle lot includes associating each of a first plurality of location tags with one of a plurality of vehicles, wherein each of the plurality of vehicles having an associated key, associating each of a second plurality of location tags with the associated key of one of the plurality of vehicles, associating each of a third plurality of location tags with one of a plurality of personnel, maintaining location information for the first plurality of location tags, the second plurality of location tags, and the third plurality of location tags by periodically using a finder to determine tag location and updating a database with the location tag location, and providing reporting based on the location information to assist in management of the vehicle lot. A system is also provided.

### RELATED APPLICATION

This application claims priority to U.S. Provisional Patent Application No. 60/___,___, entitled GEO-LOCATION SYSTEM, METHOD, AND APPARATUS, filed May 1, 2005, herein incorporated by reference in its entirety.

### BACKGROUND OF THE INVENTION

Automobile dealerships are experiencing rapidly rising insurance costs due to losses experienced related to their property. Until the recent past automobile dealerships have done little to prevent loss. In fact, automobile dealerships have little experience in developing comprehensive loss prevention programs and practices, they have no quantifiable loss prevention program, and no internal claims management function, no internal risk management function, no safety training programs and poor loss history. Most of the automobile dealerships never received a written evaluation of risk or loss prevention report from their insurer.

It is a well known fact that the direct benefit (cost savings) associated with risk management and loss prevention programs is a direct function of the scope of the implementation of the programs. In those instances where the programs are integrated into each operating facet of the business, average first year annual insurance cost savings range from 3 to 27 percent. In addition to the direct insurance cost savings, risk management and loss prevention programs can reduce inventory damage and theft.

The present invention provides a risk management and loss prevention tool by keeping tabs on high value assets, such as automobiles. A dealership in Minnesota recently experienced losses in the tens of thousands of dollars on a single Cadillac Escalade that was borrowed over the weekend by an unknown employee without the permission of the business owner.

Also, according to the American Demographics Society, Americans waste 9,000,000 hours a day looking for lost or misplaced items. Even something as trivial as losing one's car keys can be a traumatic event that causes undesired stress in a person's life, especially because losing the car keys has a cascading effect, leading to something bigger such as being late for work, school, date, or important meeting.

Furthermore, there is a need to keep certain assets secure, such as but not limited to files on a personal computer or PDA.

Thus, there is a need for a more efficient method for keeping track of and securing corporate and personal assets of high, medium, and low value to prevent loss due to stealing, abduction, misplacement, and wasted time and related stress.

### SUMMARY OF THE INVENTION

The present invention relates to a location system. Generally, this is a system for recording, storing, and retrieving location information related to high, medium, and low value assets, and people. An high value asset may be a vehicle such as, but not limited to an automobile, truck, SUV, boat, motorcycle, ATV, Segway, etc. In addition, a high value asset may be equipment such as, but not limited to construction equipment, farm equipment, manufacturing equipment. Also, a high value asset may be an item such as, but not limited to, containerized freight, art, antiques, collectables, etc. A medium value asset may be an item such as, but not limited to a job box filled with construction tools, bicycle, riding lawn mower, musical instruments, PC, PDA, cell phone, iPOD-type device, etc. A low value asset may be an item such as, but not limited to a file of paper documents such as a contract, mortgage, loan, etc., or CDs, DVDs, power tools, keys, credit cards, purses, wallets, etc. In addition, the present invention can be used to keep track of employees, children, animals, etc. Also, the present invention can be used to keep track of finished goods inventory, work in progress (WIP), components, etc. The present invention uses a location device (finder (reader, scanner, interrogator)), and a tag that includes GPS capability, memory, a processor, and a radio for wireless communication with a finder (reader, scanner, interrogator). Alternatively, the tag may be used as a location-based on-off switch in a circuit.

A general feature of the present invention is the provision of a system for recording, storing, and retrieving location data related to an asset which overcomes many of the problems found in the prior art.

A further feature of the present invention is the use of the present invention's tags as an electronic billboard.

A further feature of the present invention is the storage of data in the present invention's tags in a hashed format.

A further feature of the present invention is the access of data stored in the present invention's tags using a key or PIN.

A further feature of the present invention is the use of the provision of a private channel to allow a multiplicity of users to access a specific tag.

A further feature of the present invention is the use of tags as switches to activate and de-activate electrically operated devices.

A further feature of the present invention is the integrated use of the Microsoft software platform for automobiles (see appendices).

A further feature of the present invention is the use of the tags as switches in a General Motor's On-Star like manner, such as un-locking doors remotely, initiating an emergency call, or a call for a tow truck, etc.

A further feature of the present invention is the use of MAPTUIT as an integral part of the total solution.

A further feature of the present invention is the use of Aeris as an integral part of the total solution.

A further feature of the present invention is the provision of tags that have a new key issued each time the data in the present invention's tag is accessed, changed, modified, etc.

A further feature of the present invention is the provision of the present system at an auto auction for location purposes, this would put tags on automobiles for other purposes within the auction, and would close the loop outside the auction for other purposes.

A further feature of the present invention is the monitoring of tagged assets from an airborne platform, such as, but not limited to a helicopter, plan, unmanned vehicle, balloon, blimp, etc.

A further feature of the present invention is the monitoring of tagged assets on the ground by a third-party drive by.

A further feature of the present invention is the use of the present invention's tags as a driver in a knowledge management system.

A further feature of the present invention is the use of the present invention in a treasure hunt game to introduce the present invention to the world on a reality TV show.

A further feature of the present invention is the use of the present invention in an rally game using automobiles, bicycles, snowmobiles, boats, etc.

A further feature of the present invention is the use of the present invention in gaming.

A further feature of the present invention is the use of the present invention's tags as a personal ad that can be accessed through the system.

A further feature of the present invention is the use of the present invention's tags as navigational references, such as, but not limited to a VOR or waypoint.

A further feature of the present invention is the use of the present invention's tags telematics data to track secured freight, such as, but not limited to, containerized freight, packages, and couriers, diplomatic packages, etc.

A further feature of the present invention is the use of the present invention's system to provide weather data derived from a weather station chip in a cell phone, or car, etc., that has location, time, and date stamps, in order to provide meteorologists a more discreet picture of the weather.

A further feature of the present invention is the use of the present invention to provide location keys and ID numbers to track work-in-process, finished goods, etc., in a manufacturing or warehouse facility.

A further feature of the present invention is the use of the present invention to report grid lock conditions, pot holes, suspicious activity, etc.

A further feature of the present invention is the use of the telematics data available from a tag to record a teenage driver's performance, or record the performance of a test vehicle, race vehicle, etc.

A further feature of the present invention is the use of the present invention's tags as switches to turn off lights or appliances remotely, unlock doors, unlock garages, etc.

A further feature of the present invention is the use of the present invention's location capabilities, particularly the indoor capability, as an aid to the E911 mandate for mobile telephones, and IP telephones.

A further feature of the present invention is the provision of a web interface to set communication parameters for a personal ad on a tag or an advertisement on a tag, assign tags to a personal finder (reader, scanner, interrogator), pay for their service, etc.

A further feature of the present invention is the provision of a method for locating an asset using the wOz system available from Wheels of Zeus integrated with technology from Intellot.

One or more of these and/or other features and advantages of the present invention will become apparent from the following specification and claims.

The present invention is a location system. The preferred embodiment of the present invention is for use at an automobile dealership, however, the present invention is not to be limited to this specific context. This is not a location system for the purposes of auditing and authenticating. Rather, this is a system for recording, storing, and retrieving location information related to high, medium, and low value assets, and people. An high value asset may be a vehicle such as, but not limited to an automobile, truck, SUV, boat, motorcycle, ATV, Segway, etc. In addition, a high value asset may be equipment such as, but not limited to construction equipment, farm equipment, manufacturing equipment. Also, a high value asset may be an item such as, but not limited to, containerized freight, art, antiques, collectables, etc. A medium value asset may be an item such as, but not limited to a job box filled with construction tools, bicycle, riding lawn mower, musical instruments, PC, PDA, cell phone, iPOD-type device, etc. A low value asset may be an item such as, but not limited to a file of paper documents such as a contract, mortgage, loan, etc., or CDs, DVDs, power tools, keys, credit cards, purses, wallets, etc. In addition, the present invention can be used to keep track of employees, children, animals, etc. Also, the present invention can be used to keep track of finished goods inventory, work in progress (WIP), components, etc. The present invention uses a proprietary location device (finder (reader, scanner, interrogator)), and a tag that includes GPS capability, memory, a processor, and a radio for wireless communication with a finder (reader, scanner, interrogator). Alternatively, the tag may be used as a location-based on-off switch in a circuit.

The key differentiators of the present invention include at least the following:

1. Hashing the identifier to produce other information encrypted in the data string

2. Not for authentication / auditing purposes on an automobile dealers lot.

3. Master zero points

4. Golf Carts equipped with finder (reader, scanner, interrogator)s to aid in providing auxiliary information to monitor the accuracy of the Intellot/wOz location system

5. Courtesy cars equipped with finder (reader, scanner, interrogator)s to aid in providing auxiliary information to monitor the accuracy of the Intellot/wOz location system
6. The tag can function as a switch in a circuit to turn on and off power to attached devices
7. The tag can be connected to a cell phone to report location of a tagged asset even if the tagged asset leaves the perimeter of the Intellot local network
8. The tag can provide GPS time and date stamps as unique identifiers
9. The location data can be used to drive logistics problems, such as re-arranging a large automobile dealer's lot
10. The tags can provide telematics data, such as, but not limited to speed, acceleration, deceleration, places visited, routes, etc.

The preferred embodiment of the present invention is designed for use in the automobile industry, in applications such as, but not limited to, an automobile dealership, a car rental agency, a car repair business, a motor pool, etc. The present invention's tags are attached to an asset of interest, such as, but not limited to an automobile, automobile keys, equipment such as battery chargers, air pumps, golf carts that are often used to cruise the dealer's lot, company cell phones, company PDAs, computer laptops, tools, repair parts inventory, courtesy vehicles, deal transaction folders, and personnel. A finder (reader, scanner, interrogator), either stationary or mobile, polls the tags periodically to ascertain their location and report the location to a computer system server. An asset's location can be obtained by querying a PC, or a finder (reader, scanner, interrogator) plugged into or integrated into a mobile device, such as, but not limited to a cell phone or PDA. The present invention's tags can also record telematics data related to an automobile, such as, but not limited to speed, acceleration, deceleration, time out of a dealer's lot, time returned to a dealer's lot, etc.

The present invention also provides a novel method of using some of the apparatus components of the present invention on a rolling inventory basis to provide the benefits of location-based intelligence to the automobile dealer, and making the same system apparatus components available to a consumer for purchase and use at their own home or place of business.

The preferred embodiment of the present invention consists of several basic components, 1) a tag, 2) a mobile finder (reader, scanner, interrogator) (mobile and/or stationary), and 3) a back-end system.

In the preferred embodiment, the tag which is used as a means for locating an asset includes at minimum the following features: a microprocessor for determining the location of a tagged asset, a microprocessor with memory and processor loaded with appropriate algorithms, a means of communicating receiving and transmitting data wirelessly, and a means to power the tag In the preferred embodiment, the finder (reader, scanner, interrogator) is in the form of an SDIO plug-in that can be used with a personal digital assistant (PDA), or cell phone. The present invention contemplates that the finder (reader, scanner, interrogator) can be realized in many various form factors. Those specifically described herein are merely preferred.

The final component in the present invention is a database for recording, storing, and retrieval of information related to the location of a specific tagged asset. The database, which may be public or private, may be used for other related activities such as, but not limited to inventory control, repair work orders, targeted advertising, customer loyalty programs, Customer Relationship Management (CRM), sales force automation, distribution control, field force automation, logistics management, document control, voice and/or text communications, etc.

According to one aspect of the present invention, a method of tracking assets associated with a vehicle lot is provided. The method includes associating each of a first plurality of location tags with one of a plurality of vehicles, wherein each of the plurality of vehicles having an associated key, associating each of a second plurality of location tags with the associated key of one of the plurality of vehicles, associating each of a third plurality of location tags with one of a plurality of personnel, maintaining location information for the first plurality of location tags, the second plurality of location tags, and the third plurality of location tags by periodically using a finder to determine tag location and updating a database with the location tag location, and providing reporting based on the location information to assist in management of the vehicle lot. The reporting may include position of the vehicles, position of the keys, and/or position of the personnel. The reporting can also include the identity of each of the plurality of personnel having driven or moved one of the plurality of vehicles. This information can be determined comparing location of the each of the personnel over time with location of one of the plurality of vehicles, and location of the key associated with the one of the plurality of vehicles over time. Each of the location tags may include a housing having an associated form factor, a radio disposed within the housing, and at least one processor disposed within the housing and operatively connected to at least one of the at least one processor.

According to another aspect of the present invention, a method of tracking assets associated with a vehicle lot and recovering costs for use of the method by providing an additional service to a customer is provided. The method includes associating each of a first plurality of location tags with one of a plurality of vehicles, wherein each of the plurality of vehicles having an associated key, associating each of a second plurality of location tags with the associated key of one of the plurality of vehicles, associating each of a third plurality of location tags with one of a plurality of personnel, maintaining location information for the first plurality of location tags, the second plurality of location tags, and the third plurality of location tags by periodically using a finder to determine tag location and updating a database with the tag location, providing reporting based on the location information to assist in management of the vehicle lot, and making available to the customer one or more location tags and one or more finders for purchase with one of the vehicles to thereby at least partially recover costs associating with tracking of assets. Each of the location tags preferably includes a housing having a form factor, at least one processor disposed within the housing, a radio disposed within the housing and operatively connected to at least one of the at least one processor. The finder preferably includes a finder housing having a form factor, at least one finder processor disposed within the finder housing, a finder radio disposed within the finder housing and operatively connected to at least one of the at least one finder processor. The method may also include using the finder to locate one of the plurality of vehicles during interaction with the customer to thereby demonstrate usefulness of the finder and one of the location tags to assist in selling of the finder and location tags.

According to another aspect of the present invention, a location system for assets associated with a vehicle lot is provided. The location system includes a plurality of tags, at least one of the tags associated with a personnel member, at least one of the tags associated with a vehicle, and at least one of the tags associated with a key for the vehicle. There is at least one finder adapted for periodically obtaining position information for each of the plurality of tags, wherein the at least one finder is adapted to determine position information of tags indoor or outdoor, the at least one finder being adapted to determine position of tags within a range of a plurality of miles from the finder. There is a database for storing information associated with each of the plurality of tags including position information received from the finder. There is also a software component adapted to access the database and provide reporting, the reporting comprising position of the vehicle, position of the key for the vehicle, position of the personnel member, identify of all personnel having driven or moved the vehicle within a selected time frame, all vehicles having left the range.

### BRIEF DESCRIPTION OF THE DRAWINGS

FIG. 1 is a block diagram of the essential components of a tag of the present invention.

FIG. 2 is a block diagram of the essential components of a finder (reader, scanner, interrogator) of the present invention.

FIG. 3 is an illustration of the general topography of the present invention.

FIG. 4 is an illustration of the general topography of the present invention for an automobile dealer's lot.

FIG. 5 is a flow chart illustrating a methodology according to one embodiment of the present invention.

FIG. 6 is a flow chart illustrating a methodology according to another embodiment of the present invention.

### DETAILED DESCRIPTIONS FOR PREFERRED EMBODIMENTS

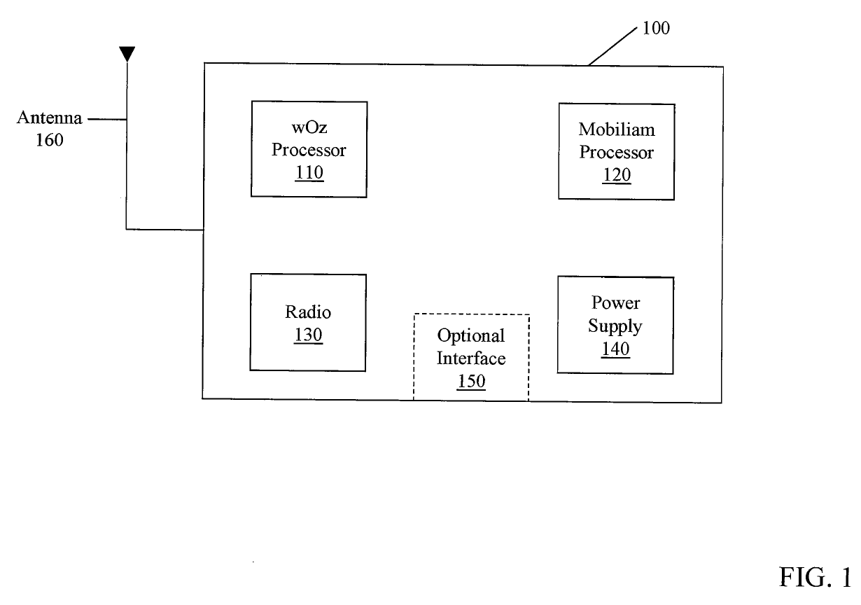

FIG. 1 is a block diagram of components of a tag that is part of the integrated solution described in the present invention. The tag preferably includes the components of the tag available from Wheels of Zeus known as a WOz tag. The tag 100 can be constructed in a wide variety of form factors, such as, but not limited to those described in Chart 1 below.

CHART 1
Tag Form Factors
Key Fobs
Keys
Watches
Jewelry
Luggage Tags
Wristbands/Anklebands
Tags That Can Be Sewn Into Clothing
Automobile Cigarette Lighters
Badges
Integrated In A Memory Stick
Combination Automobile Cigarette Lighter With USB Interface
AND
Memory Stick Form Factor
Combination Automobile Cigarette Lighter With USB Interface
AND
Intellot - wOz Tags With USB Connections
SDIO Cards
Compact Flash Cards
PCMCIA Cards

In any form factor, tag 100 preferably includes a wOz processor 110, a processor 120 which is sometimes referred to as an “Intellot processor”, a radio 120, a power supply 130, an antenna 150, and an optional interface 140.

The wOz processor 110 includes a location data engine for use with the present invention and is available from Wheels of Zeus. The Intellot processor 120 contains RAM and a computer, such as, but not limited to a PowerPC. The Intellot processor 120 integrates and controls the tags functions as well as performs compute applications as needed for recording, storing, and retrieving location data and other data associated with a tagged asset. Tag 100's main communication interface is via radio 120 which is connected to antenna 150. Radio 120 is a preferably a wOz radio available from Wheels of Zeus. Alternatively, radio 120 can be a radio such as, but not limited, to an 802.11b, 802.11a, 802.11g, Wi-Fi, Bluetooth, UWB, GSM, etc. The tag's microprocessors may be built on hardware including, but not limited to, Field Programmable Gate Arrays (FPGA), Application Specific Integrated Circuits (ASIC), System-On-A-Chip (SoC), etc.

The power supply 130 for tag 100 may be solar, battery, passive type powered by RF energy radiated from a finder (reader, scanner, interrogator), or a battery assisted passive type that uses a combination of battery and RF energy. Alternatively, the power for tag 100 may come from an automobile battery circuit from an interface such as, but not limited to a cigarette lighter-type socket.

The optional interface 140 may be a port such as, but not limited to an RJ-11 jack for telephone twisted pair, an RJ-45 jack for an Ethernet connection, IEEE 1394 Fire Wire connection, USB, RS-232, PCMCIA slot, SDIO connection, Compact Flash slot, etc. The PCMCIA slot can be used as a wireless integration point for systems such as, but not limited to, Bluetooth, 802.11a, 802.11b, 802.11g, GSM, UWB, etc.

Hash codes are well known in the art. The use of a one-way hash code in the present invention is intended to ensure the security of data contained in tag 100. The hash code is a check sum that is the result of a computation algorithm that can as an example be created from a PIN code and information contained within the wOz processor 110 and/or Intellot processor 120.

Alternatively, the circuitry for tag 100 may be printed directly on a flexible medium using technology developed by a company, such as Cypak.

Optionally, tag 100 may include a two-piece locking strap (not shown) that can be used to attach tag 100 to an asset. The two-piece strap may be made from materials such as, but not limited to, plastic, metal, etc. The locking mechanism on a two-piece strap may be a releasing or non-releasing type. The two-piece locking strap can optionally be a part of the power circuit and cause the tag to become disabled when the two-piece locking strap is disconnected.

Optionally, tag 100 can include an LED to indicate that it is being communicated with. An LED is a Light-Emitting Diode, which is a small semiconductor device that emits light when charged with electricity. LEDs come in many colors, and some LEDs contain multiple elements and are therefore capable of multiple colors.

Optionally, tag 100 may also include a radio frequency identification (RFID) chip. RFID is well known in the art and is an automatic data capture (ADC) technology comprised of “tags”, which are microprocessors, and fixed or mobile scanners known as “readers”, or “interrogators”. RFID chips consist of three basic types; read-only, write-only, or read-write. Interrogators read and/or write data from RFID chips via low power radio frequency (RF) signals. The optional RFID chip may be either an active, passive, or battery assisted type. Active type RFID chips are powered by a battery, whereas passive type RFID chips are powered by RF energy generated by an interrogator. RFID systems may operate on one of several frequencies, which include, but are not limited to 125-134 kHz, 13.56 MHz, 420-450 MHz, 868-915 MHz, 2.4 GHz, and 5.8 GHz.

Optionally, tag 100's circuitry can be cryogenically processed to reduce the resistance of the conductive materials of the tag to enable the tag to draw considerably less power to operate the tag, thus extending the operational life of the tag.

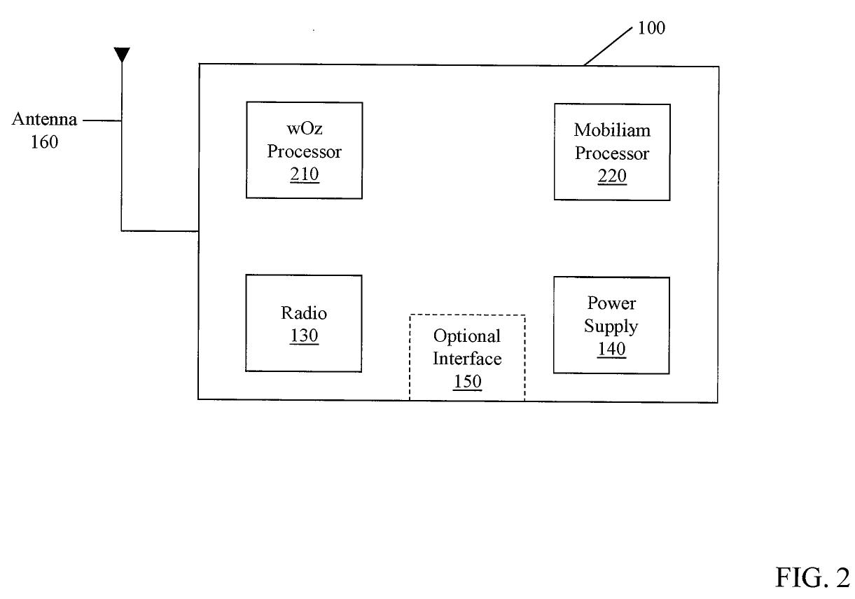

FIG. 2 is a block diagram of the essential components of a finder (reader, scanner, interrogator). The finder (reader, scanner, interrogator) can be constructed in a wide variety of form factors, such as, but not limited to those described in Chart 2 below. Standalone Handheld Device(s)

CHART 2
Intellot Finder (reader, scanner, interrogator) Form Factors
SDIO Cards
Secure Digital Input/Output

A standard for accessory devices that extends the functionality of devices with SD card
slots.
While an SD card is a memory card that simply stores files, an SDIO card can be complete
hardware accessory. Examples of SDIO cards include Wi-Fi and Bluetooth adapters, GPS
receivers, TV tuners, cameras, RFID readers, and fingerprint readers.
SDIO cards are usually longer than SD cards, and thus “stick out” from the device into
which they are inserted.
A device with an SDIO card slot can also accept standard SD memory cards, but not
necessarily vice-versa. A device must specifically be “SDIO-capable” in order to be
compatible with SDIO cards.
Single Purpose Standalone Stationary Device(s)
Single Purpose Standalone Mobile Device(s)
Key Fobs
Jewelry
Watches
Compact Flash Cards
A CompactFlash (CF) card is a popular memory card developed by SanDisk in 1994 that
uses flash memory to store data on a very small card. A CompactFlash card makes data
easy to add to a wide variety of computing devices, including digital cameras and music
players, desktop computers, personal digital assistants (PDAs), digital audio recorders, and
photo printers.
Based on the Personal Computer Memory Card International Association (PCMCIA) PC
Card specifications, CompactFlash measures 43 × 36 mm (about the size of a matchbook)
and is available with storage capacities ranging up to 1 gigabyte (GB), with higher
capacities corresponding to higher prices. CompactFlash is similar in size to the
SmartMedia card, but larger than the newer, postage stamp-sized alternatives, Multimedia
Card and Secure Digital (SD) card. There are two different types of CF cards, of different
thicknesses (to accommodate different capacities): Type I CF cards are 3.3 mm thick,
compared to 5.5 mm for Type II cards.
Because flash is nonvolatile memory, stored data is retained when a device's power source
is turned off or lost. CF cards feature solid-state construction, which makes them much
more rugged than most traditional storage devices. The operating shock rating (basically,
what height can you drop them from and have them still work) for CF cards is 2,000 Gs
compared to a 100-200 G rating for the mechanical drive of the typical portable computing
device. This translates to a drop to the floor from 10 feet, as compared to a single foot for
the mechanical disk drive.
CompactFlash is a popular card choice for use with personal digital assistants (PDAs) and
digital cameras. A high-end version, Ultra CompactFlash, is optimized for more
demanding photography, such as a quickly shot succession of high-resolution pictures, or
pictures of a moving subject, such as a bicycle race. Ultra CompactFlash provides a
transfer rate twice that of SanDisk's standard memory cards, so that data can be quickly
saved and the camera can be ready to capture another image.
There are adapters available for use with CompactFlash to enable access through a standard
diskette drive, USB (Universal Serial Bus) port or PC card slot. Most platforms and
systems that support the PCMCIA ATA (Advanced Technology Attachment) standard also
support CompactFlash.
PCMCIA Cards
Integrated Into Cell Phones
Integrated Into Cell Phone Batteries
PDA Sleds
Integrated Into GPS Receivers

In any form factor, finder (reader, scanner, interrogator) 200 preferably includes a wOz processor 210, an Intellot processor 220, a radio 120, a power supply 130, an antenna 150, and an optional interface 140.

The wOz processor 210 is the engine for locating tagged assets. The processor 220 contains RAM and a computer, such as, but not limited to a PowerPC. The Intellot processor 220 integrates and controls the finder (reader, scanner, interrogator)'s functions as well as performs computer applications as needed for recording, storing, and retrieving location data and other data associated with a tagged asset. The finder (reader, scanner, interrogator)'s microprocessors may be built on hardware including, but not limited to, Field Programmable Gate Arrays (FPGA), Application Specific Integrated Circuits (ASIC), System-On-A-Chip (SoC), etc.

Finder (reader, scanner, interrogator) 200's main communication interface is via radio 120 which is connected to antenna 150. Radio 120 is a proprietary wOz radio. Alternatively, radio 120 can be a radio such as, but not limited, to an 802.11b, 802.11a, 802.11g, Bluetooth, UWB, GSM, etc.

The power supply 130 for finder (reader, scanner, interrogator) 200 may be an onboard battery for a mobile finder (reader, scanner, interrogator), or alternatively a finder (reader, scanner, interrogator) in a car or golf cart may take power directly from the vehicle's battery, or alternatively may be AC power for a stationary

The optional interface 140 may be a port such as, but not limited to an RJ-11 jack for telephone twisted pair, an RJ-45 jack for an Ethernet connection, IEEE 1394 Fire Wire connection, USB, RS-232, PCMCIA slot, SDIO connection, Compact Flash slot, etc. The PCMCIA slot can be used as a wireless integration point for systems such as, but not limited to, Bluetooth, 802.11a, 802.11b, 802.11g, GSM, UWB, etc.

Optionally, finder (reader, scanner, interrogator) 200 may include devices such as, but not limited to, bar code reader, RFID reader, and digital camera for taking pictures or to scan and decode bar codes, a voice radio, a magnetic stripe reader, and voice recognition software in order to receive verbal inputs as a means of interface with the finder (reader, scanner, interrogator) 200.

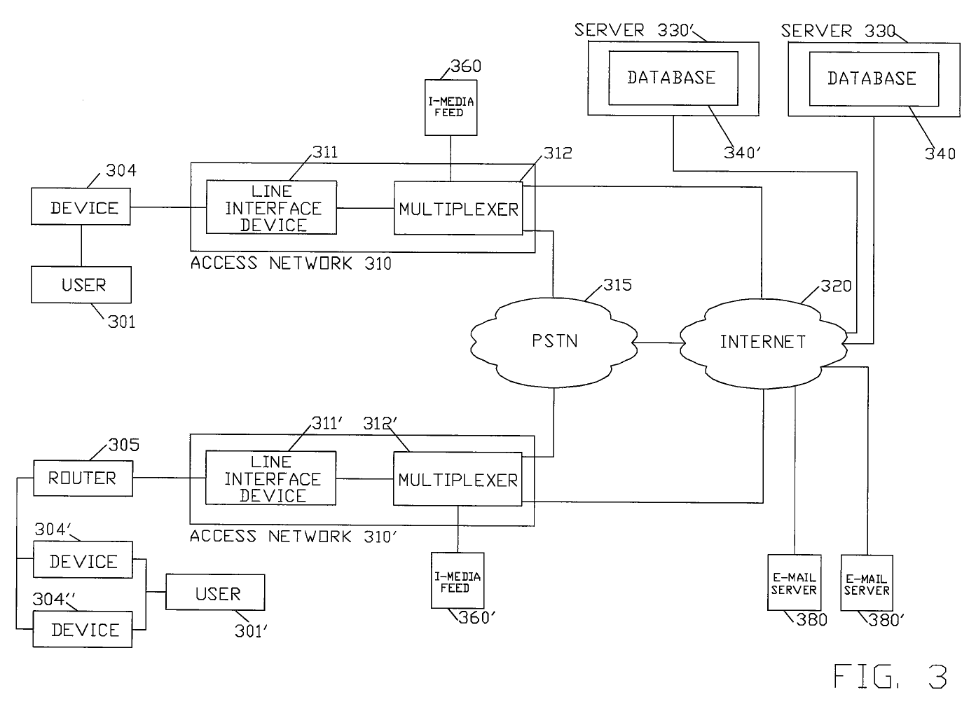

FIG. 3 illustrates the general topography of the preferred embodiment of the present invention. The present invention provides servers 330, 330′ which contain databases 340 and 340′ respectively. Database 340′ is used to store information related to a tagged asset, including demographic information. This demographic information stored on Database 340′ can be used to drive a messaging system.

Databases 340, 340′ are accessible via the Internet 320. Servers 330, 330′ can be a collection of one or more servers, computers, etc. that are able to provide functionality for the present invention. Server 330, 330′ can include multiple similar and distinct hardware components or models, such as but not limited to Dell, IBM, Sun, HP and required operating system software such as but not limited to UNIX, Microsoft Windows, Redhat Linux and other required supportive operating systems. In addition, servers 330, 330′ can include a multitude of supporting software components required to support the implementation of the present invention including, but not limited to Apache Web Server software, Microsoft IIS Web Server Software, Oracle, MySQL, Lightweight Directory Access Protocol (LDAP), Domain Name System (DNS) and HyperText Transfer Protocol (HTTP), Voice recognition software, Voice application engines, Application engines, and CORBA software and middleware. Databases 340, 340′ represents the storage of data including software required to run servers 330, 330′ and provide functionality for the present invention. Databases 340, 340′ can be attached to server 330, 330′ via network transport or bus connections including, but not limited to Small Computer Systems Interface (SCSI), Internet SCSI (iSCSI), Peripheral Component Interconnect (PCI), Fiber optic transport, Fiber Channel, TCP/IP, and SNA. In addition, databases 340, 340′ can be a collection of one or more media storage units that are located locally or remotely to servers 330, 330′. Databases 340, 340′ can be built on storage such as, but not limited to, magnetic and optical media. These systems and associated software may be housed in an Internet Data Center equipped with fully redundant subsystems, such as multiple fiber trunks coming from multiple sources, redundant power supplies, and backup power generators. Databases 340, 340′ may also utilize firewall technology to securely protect the information stored in databases 340, 340′. In addition, database 340, 340′ may provide secure access through the use of passwords, Personal Identification Numbers (PIN), and/or biometric identification. Such systems are commonly used in applications such as those described in the preferred embodiment of the present invention.

FIG. 3 represents the preferred embodiment of the present invention, in which two users 301, 301′ are connected via access networks 310, 310′.

Access Networks 310, 310′ may be configured as Cable TV or PSTN, and can be used for accessing information stored in databases 340, 340′, and for messaging users 301, 301′ and/or devices 304, 304′, 304″ which are connected to one of these types of networks. Devices 304, 304′, 304″ may be devices such as, but not limited to, finder (reader, scanner, interrogator) 200 (not shown), PCs, TVs, set-tops boxes, Internet appliances, e-mail stations, telephones, kiosks, ATMs, etc. Devices 304′, 304″ are shown connected to a router 305 which is connected to Access Network 310′. As an example, router 305 can be of the type included in a Linksys “EtherFast 10/100 Network in a Box”, product number FENSK05.

At a minimum, access networks 310, 310′ are typically configured with a multiplexer 312, 312′ and line interface device 311, 311′. The line interface device 31 1, 311′ may be configured as a stand-alone modem or codec, within a PCMCIA card, as a wireless POP, or integrated into devices 304, 304′, 304″ such as, but not limited to, finder (reader, scanner, interrogator) 200 (not shown) TVs, PCs, PDAs, tablets, telephones, set-top boxes, etc.

The multiplexer 312, 312′ may be located at the Central Office, or Digital Loop Carrier of a telephony network, or the Head-End, or intermediate node of a Cable TV network, or at a third-party Application Server Provider's office, or the network center of an auction house, etc. The multiplexer 312, 312′ is capable of receiving analog and digital signals including, but not limited to interactive media (I-Media) feed 360, 360′, Internet traffic 320 including e-mail from e-mail servers 380, 380′ and data from servers 340, 340′, and voice feed from the PSTN 315, and data from servers 340, 340′, etc. The I-Media feed 360, 360′ may be a service such as, but not limited to, an auto auction. I-Media feed 360, 360′ may originate sources such as, but not limited to, video servers, satellite feeds, etc. The multiplexed signal from multiplexer 312, 312′ may be transmitted over a variety of transmission medium, including but not limited to, coaxial cable, fiber optic cable, twisted pair, plastic fiber cable, airwaves, or a combination of these.

Databases 340, 340′ can be accessed by a specific user 301, 301′ through the Internet 320 to add, modify, and delete data related to a tagged asset.

The preferred embodiment of the present invention as shown in FIG. 3 illustrates server 330, 330′ residing on the Internet. Optionally, it may reside on a Virtual Private Network (VPN), a wide-area network (WAN), or local area network (LAN). The server 330, 330′ has all of the necessary hardware and software required to store a user's 301, 301′ demographic data, as well as control the access to the user's 301, 301′ data from any computer equipped with an Internet browser, such as, but not limited to Microsoft Internet Explorer, etc.

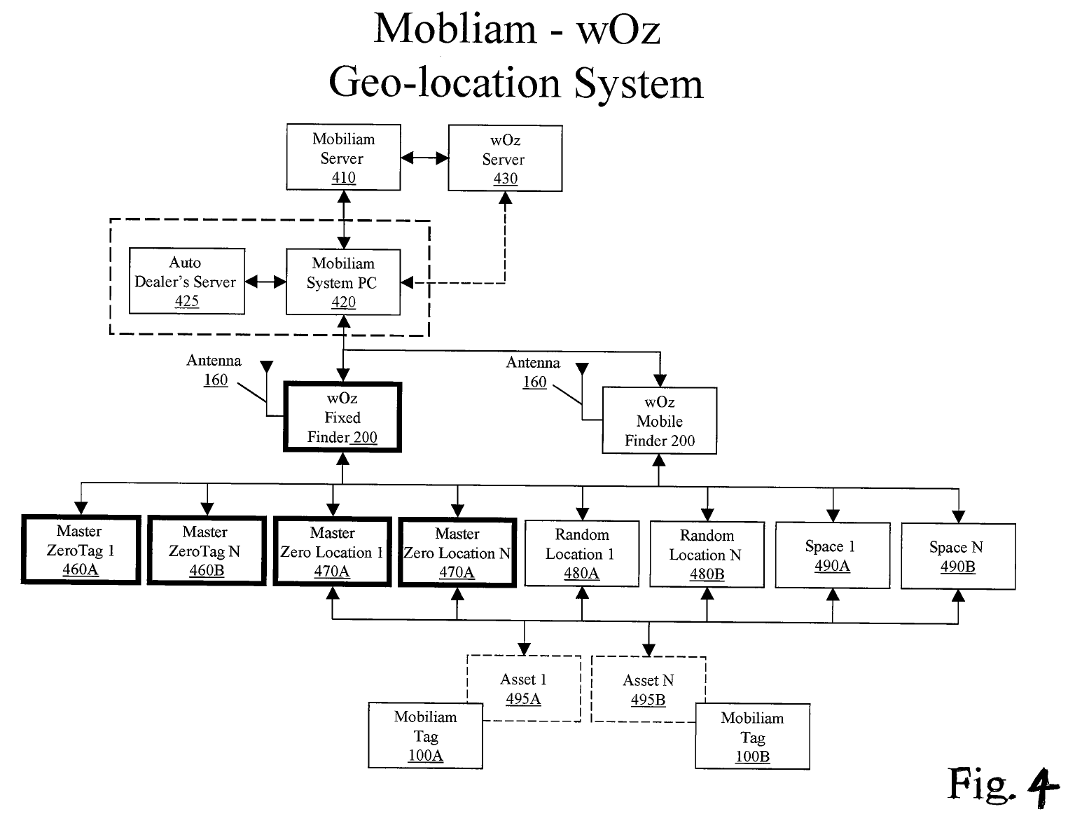

FIG. 4 is an illustration of the general topography of the present invention for an automobile dealer's lot.

The Intellot System PC 420 is the device that coordinates the present invention. The Intellot System PC 420 is connected to the Intellot Server 410 and the wOz Server 430 either directly, or via the Intellot Server 410. Intellot Server 410 and the wOz Server 420 are accessible via the Internet.

The Intellot System PC 420 acts as an intermediary to communicate with the local wOz Fixed finder (reader, scanner, interrogator)s and wOz Mobile finder (reader, scanner, interrogator)s 200 to either locate Intellot Tags 100A, 100B that are moving about within the perimeter of these finder (reader, scanner, interrogator)s, OR to measure the accuracy of the location system by communicating with surveyed locations known as Master Zero Tags 460A, 460B, Intellot Tags 100A, 100B located in Master Zero Locations 470A, 470B, or by correlating Intellot Tags 100A, 100B to surveyed parking spaces 490A, 490B AND the wOz Server 430 and the Auto Dealers Server 425.

Intellot Tags 100A, 100B can be affixed to assets 495A, 495B such as, but not limited to an automobile, automobile keys, equipment such as battery chargers, air pumps, golf carts that are often used to cruise the dealer's lot, company cell phones, company PDAs, computer laptops, tools, repair parts inventory, courtesy vehicles, deal transaction folders, and personnel.

Server 410 also and/or System PC 420 and/or Auto Dealer's Sever 425 databases and programs, which may be public or private, may be used for other related activities such as, but not limited to inventory control, repair work orders, targeted advertising, customer loyalty programs, Customer Relationship Management (CRM), sales force automation, distribution control, field force automation, logistics management, document control, voice and/or text communications, etc.

A novel marketing feature of the present invention is a means to expand the business opportunity in the automotive vertical market from the point of view of a sale to a consumer of a system for their own use. A sales person will incidentally be demonstrating the present invention as they use a portable finder (reader, scanner, interrogator) to navigate to a car on the lot. Dealers sell extended warranties, paint protection, bed liners, etc, why not a car and key location system? Of course, the consumer will need an inexpensive stand-alone finder (reader, scanner, interrogator), or one in the form of an SDIO card that can be plugged into a PDA, cell phone, etc., so that they can find their car and keys. The consumer would also have the option of purchasing additional key fobs or tags for other cars and keys, or other items of interest. This is an alternative way of getting the dealer to get his location system paid for by the consumer, while making extra money. The dealer uses the system to track his cars until a car is sold. The dealer just needs to add it to their dealer installed item invoice that they are always slapping on the window. Of course, the dealer can also sell antennae and software so that a consumer can put up a perimeter at their house to track dogs, children, etc. The same finder (reader, scanner, interrogator) works with any form factor tag.

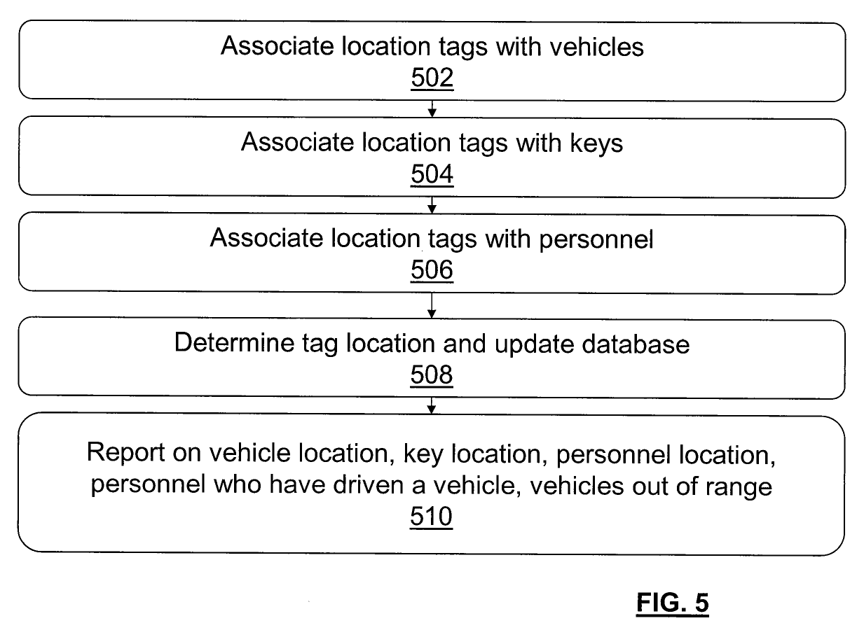

FIG. 5 illustrates one embodiment of the methodology of the present invention. In step 502, location tags are associated with vehicles. In step 504, location tags are associated with keys. In step 506, location tags are associated with personnel. In step 508, tag locations are determined and a database is updated accordingly. Preferably, tag locations are determined by periodic updates for all tags as well as through queries for specific tags when desirable. In step 510 reporting takes place. The reporting can be reporting on vehicle location, key location, personnel location, personnel who have driven a particular vehicle, vehicles out of range, or other types of reporting.

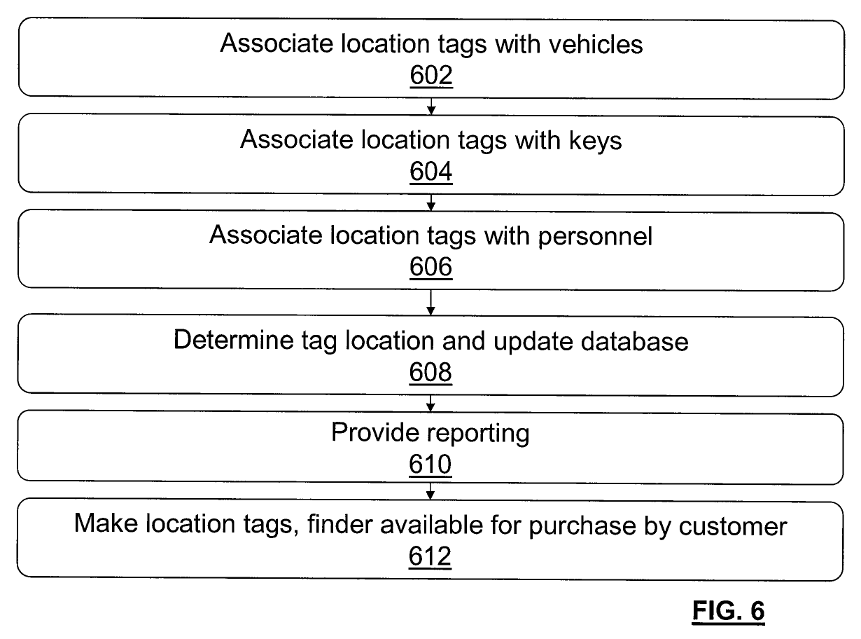

FIG. 6 illustrates another embodiment of the methodology of the present invention. In step 602, location tags are associated with vehicles. In step 604, location tags are associated with keys. In step 606, location tags are associated with personnel. In step 608, tag location is determined and a database is updated accordingly. In step 610, reporting is provided. In step 612, the location tags and finder are made available for purchase by a customer. In this way, the present invention contemplates that vehicle dealers can recover at least a portion of the costs associated with using the location system of the present invention. Of course, the present invention contemplates that a customer may be interested in location tags of varying form factors depending upon the intended use. The present invention also contemplates providing software to the customer for use with their location tag(s) and finder which is configured for or adaptable to the customer's specific use.

Although, the preferred embodiment of the present invention discusses the use of wOz tag technology, other RFID or GPS tag technologies can be used. Some examples of companies that provide this type technology include, but are not limited to, S5 Wireless, Coronis Systems, WhereNet, etc.

A general description of the present invention, as well as a preferred embodiment, and alternative aspects of the present invention has been set forth above. Those skilled in the art to which the present invention pertains will recognize and be able to practice additional variations in the methods, systems, and applications other than automotive which fall within the teachings of this invention. The present invention further provides for variations in the manner in which such assets are identified and authenticated. Accordingly, all such modifications and additions are deemed to be within the scope of the invention.

What is claimed is:

1. A method of tracking assets associated with a vehicle lot, comprising: associating each of a first plurality of location tags with one of a plurality of vehicles,
wherein each of the plurality of vehicles having an associated key; associating each of a second plurality of location tags with the associated key of one of the plurality of vehicles;
associating each of a third plurality of location tags with one of a plurality of personnel;
maintaining location information for the first plurality of location tags, the second plurality of location tags, and the third plurality of location tags by periodically using a finder to determine tag location and updating a database with the location tag location;
providing reporting based on the location information to assist in management of the vehicle lot.

2. The method of claim 1 wherein the reporting comprises position of at least one of the plurality of vehicles.

3. The method of claim 1 wherein the reporting comprises position of at least one of the plurality of keys.

4. The method of claim 1 wherein the reporting comprises position of at least one of the personnel.

5. The method of claim 1 wherein the reporting comprises identity of each of the plurality of personnel having driven or moved one of the plurality of vehicles.

6. The method of claim 5 wherein the identify of each of the plurality of personnel having driven or moved one of the plurality of vehicles being determined by comparing location of the each of the personnel over time with location of one of the plurality of vehicles, and location of the key associated with the one of the plurality of vehicles over time.

7. The method of claim 1 wherein each of the location tags comprises a housing having an associated form factor, a radio disposed within the housing, and at least one processor disposed within the housing and operatively connected to at least one of the at least one processor.

8. A method of tracking assets associated with a vehicle lot and recovering costs for use of the method by providing an additional service to a customer, the method comprising: associating each of a first plurality of location tags with one of a plurality of vehicles,
wherein each of the plurality of vehicles having an associated key; associating each of a second plurality of location tags with the associated key of one of the plurality of vehicles;
associating each of a third plurality of location tags with one of a plurality of personnel;
maintaining location information for the first plurality of location tags, the second plurality of location tags, and the third plurality of location tags by periodically using a finder to determine tag location and updating a database with the tag location;
providing reporting based on the location information to assist in management of the vehicle lot;
making available to the customer one or more location tags and one or more finders for purchase with one of the vehicles to thereby at least partially recover costs associating with tracking of assets;
wherein each of the location tags comprises a housing having a form factor, at least one processor disposed within the housing, a radio disposed within the housing and operatively connected to at least one of the at least one processor;
wherein the finder comprises a finder housing having a form factor, at least one finder processor disposed within the finder housing, a finder radio disposed within the finder housing and operatively connected to at least one of the at least one finder processor.

9. The method of claim 8 wherein the reporting comprises position of at least one of the plurality of vehicles.

10. The method of claim 8 wherein the reporting comprises position of at least one of the plurality of keys.

11. The method of claim 8 wherein the reporting comprises position of at least one of the personnel.

12. The method of claim 8 wherein the reporting comprises identity of each of the plurality of personnel having driven or moved one of the plurality of vehicles.

13. The method of claim 12 wherein the identify of each of the plurality of personnel having driven or moved one of the plurality of vehicles being determined by comparing location of the each of the personnel over time with location of one of the plurality of vehicles, and location of the key associated with the one of the plurality of vehicles over time.

14. The method of claim 8 further comprising using the finder to locate one of the plurality of vehicles during interaction with the customer to thereby demonstrate usefulness of the finder and one of the location tags.

15. A location system for assets associated with a vehicle lot, the location system comprising:
a plurality of tags, at least one of the tags associated with a personnel member, at least one of the tags associated with a vehicle, and at least one of the tags associated with a key for the vehicle;
at least one finder adapted for periodically obtaining position information for each of the plurality of tags, wherein the at least one finder being adapted to determine position information of tags indoor or outdoor, the at least one finder being adapted to determine position of tags within a range of a plurality of miles from the finder;
a database for storing information associated with each of the plurality of tags including position information received from the finder;
a software component adapted to access the database and provide reporting, the reporting comprising position of the vehicle, position of the key for the vehicle, position of the personnel member, identify of all personnel having driven or moved the vehicle within a selected time frame, all vehicles having left the range.
